(19) United States
(12) Patent Application Publication
(10) Pub. No.: US 2006/0229371 A1
(43) Pub. Date: Oct. 12, 2006

(54) Composition for preparing rigid polyurethane foam and rigid polyurethane foam made therefrom

(75) Inventors: II-Yoong Park, Masan (KR); Ju-Hyun Kim, Changwon (KR)

Correspondence Address: BIRCH STEWART KOLASCH & BIRCH, PO BOX 747, FALLS CHURCH, VA, 22040-0747, US

(73) Assignee: LG ELECTRONICS INC., SEOUL (KR)

(21) Appl. No.: 10/542,379

(22) PCT Filed: Jan. 17, 2003
(86) PCT No.: PCT/KR03/00109

§ 371 Date: Apr. 10, 2006

(51) Int. Cl. C08J 9/14

(52) U.S. Cl. 521/98

(57) ABSTRACT

Composition for preparing a rigid polyurethane foam improved adhesive strength, and a rigid polyurethane foam made therefrom are provided. The composition for preparing a rigid polyurethane foam is prepared using cyclopentane system as a physical blowing agent, and polyols having a low viscosity, and has an increased adhesive strength without damages of other properties.

### TECHNICAL FIELD

The present invention relates to a composition for polyurethane foam, and more particularly, provides a composition for rigid polyurethane foam with improved adhesive strength, among other physical properties. The composition for the polyurethane foam has an excellent adhesive property to a material of a refrigerator.

### BACKGROUND ART

Rigid polyurethane foam is commonly used as a material for maintaining strength of a building, a car or a refrigerator as well as an insulation material.

The rigid polyurethane foam is prepared by reacting suitable polyisocyanate with isocyanate group-reactive compounds in the presence of a blowing agent. As blowing agents, chlorofluorocarbon (CFC)-based compounds such as CFC-11 and hydrochlorofluorocarbon (HCFC)-based compounds such as HCFC-141b are conventionally used.

CFC-11 has advantage to fabricate foam having excellent insulation characteristics due to its low heat conductivity. However, as widely known, it has been prohibited to fabricate and use CFC-11, since it causes serious environmental problems such as an ozone layer destruction effect and a greenhouse effect. HCFC also contains chlorine and can also cause destruction of the ozone layer, even though it is less serious compared to CFC.

Thus, demands on a new blowing agent which may not cause the environmental problems as CFC or HCFC does are increasing. One of substitutes that have been developed is a cyclopentane-based blowing agent. However, the cyclopentane-based blowing agent has a problem that it is not good in its insulation property due to high heat conductivity compared to CFC-11 or HCFC-114b. Thus, many researches are conducted to suitably select the ingredients besides a blowing agent and adjust the mixture ratio between the ingredients in the composition for preparing foam. Especially, in order to increase an adhesive strength, one of critical characteristics of rigid polyurethane foam, various attempts, for example, adding several special additives thereto, have been made.

Unfortunately, however, there has been no satisfying outcome for obtaining a composition for preparing rigid polyurethane foam having an improved adhesive strength without damaging other properties such as a compression strength, a dimensional stability, flowability, a demolding property or heat conductivity.

### TECHNICAL GIST OF THE PRESENT INVENTION

Therefore, it is one object of the present invention to provide a composition for preparing rigid polyurethane foam having an increased adhesive strength while maintaining other properties.

Another object of the present invention is to provide rigid polyurethane foam fabricated from the composition for preparing rigid polyurethane foam.

### DETAILED DESCRIPTION OF THE INVENTION

To achieve the above object, there is provided a composition for preparing rigid polyurethane foam capable of increasing an adhesive strength while maintaining its inherent physical properties by using a cyclopentane-based blowing agent and suitably adjusting the kind and content of polyol in row materials for preparing polyurethane foam. According to the present invention, the composition for preparing rigid polyurethane foam comprises:

(1) 100 weight parts of a polyol mixture consisting of:

40-50 weight parts of polyol B having a OH-value of 390, which is obtained by polymerization of an organic oxide using toluene diamine (TDA) of a tetra-valent functional group as an initiator; 30-40 weight parts of polyol G having a OH-value of 450, which is obtained by mixing sucrose of a octa-valent functional group and glycerin of tri-valent functional group; and 20-30 weight parts of polyol H having a OH-value of 430, which is obtained by mixing sucrose of a octa-valent functional group and glycerin of tri-valent functional group;

(2) 2.0-4.0 weight parts of water;

0.3-3.0 weight parts of catalyst mixture consisting of 0.1-1.0 weight parts of gelling catalyst A; 0.1-1.0 weight parts of blowing catalyst B; and 0.1-1.0 weight parts of trimerizing catalyst E;

(4) 1.0-4.0 weight parts of a silicon surface-active agent;

0.5-1.5 weight parts of PFA (polyfluoroalcane);

10-20 weight parts of cyclopentane; and

140-170 weight parts of polyisocianate.

If the above ingredients are used with an amount beyond the above ranges, an improved adhesive strength cannot be obtained, and other properties such as density, intensity and a demolding property will deteriorate. Thus, they are limited to the above composition range.

Preferably, the composition for preparing rigid polyurethane foam in accordance with the present invention comprises:

(1) 100 weight parts of a mixed polyol consisting of:

40 weight parts of polyol B having a OH-value of 390, which is obtained by polymerization of an organic oxide using toluene diamine (TDA) of a tetra-valent functional group as an initiator; 30 weight parts of polyol G having a OH-value of 450, which is obtained by mixing sucrose of a octa-valent functional group and glycerin of tri-valent functional group; and 20-30 weight parts of polyol H having a OH-value of 430, which is obtained by mixing sucrose of a octa-valent functional group and glycerin of tri-valent functional group;

(2) 2.0 weight parts of water;

1.5 weight parts of catalyst mixture consisting of 0.6 weight parts of gelling catalyst A; 0.4 weight parts of blowing catalyst B; and 0.5 weight parts of trimerizing catalyst E;

(4) 2.0 weight parts of a silicon surface-active agent;

(5) 1.0 weight parts of PFA (polyfluoroalcane);

(6) 17 weight parts of cyclopentane; and

(7) 148.2 weight parts of polyisocianate.

Among the above composition, combination of polyols makes the most direct influence on the increase of the adhesive strength. Combination of polyols used in the present invention will be described as follows.

Polyol

Currently, polyol commonly used in the polyurethane industry is a poly-functional alcohol with an ether (R—O—R′) structure, which is obtained by polymerization of an organic oxide using a compound having two or more active hydrogens as an initiator.

Eight types of polyol A-I were used in experimentation of the present invention, as follows.

Polyol A used in the present invention is obtained by polymerization of an organic oxide using sorbitol of a hexa-valent functional group as an initiator.

Polyol B, which is used in the present invention, is obtained by polymerization of an organic oxide using TDA (toluenediamine) of a tetra-valent functional group as an initiator, and has an OH-value of 390.

Polyol C is obtained by using the same method as that of polyol B except for using TDA having higher viscosity and OH value than that used for polyol B.

Polyol D is obtained by polymerization of an organic oxide using ester of bi-valent functional group as an initiator.

Polyol E is obtained by polymerization of an organic oxide using glycerine of a tri-valent functional group as an initiator.

Polyol F is obtained by polymerization of an organic oxide using MDA (methyl diisocyanate) of a tetra-valent functional group as an initiator.

Polyol G, which is used in the present invention, is obtained by mixing sucrose of an octa-valent functional group and glycerine of a tri-valent functional group, and has an OH-value of 450.

Polyol H, which is used in the present invention, is obtained by mixing sucrose of an octa-valent functional group and glycerin of a tri-valent functional group, and has 430 OH-value, slightly lower viscosity and OH-value than those of polyol G.

Polyol I is obtained by polymerization of an organic oxide using a TEOA (Triethanol amine) of a tri-valent functional group as an initiator.

Silicon Surface-Active Agent

In the present invention, the silicon surface-active agent improves a mixing efficiency in mixture having very low mutual solubility and stabilizes a cell by inhibiting irregular formation and growth of air foam, as in a general rigid polyurethane foam. The silicon surface-active agent used in the present invention includes B-8462, L-6900, and the like, which may be used in the amount of 2-4 parts by weight, and preferably, 2.0 parts by weight, based on 100 weight parts of polyol.

Polyfluoroalkane/Perfluoro Carbon

In order to overcome the high heat conductivity, the worst shortcomings of the cyclopentane group, researches have been made on an MCR (Micro-Cellular Rigid) foam technique. Accordingly, several types of alkylene oxide systems have been developed to obtain generalization of a corresponding composition. Polyfluoroalkane increase a nucleating effect at an initial stage of reaction to harden an initially generated micro cell, whereby the initial cell size is maintained to be fine and an insulation effect is improved. In the present invention, polyfluoroalkane is used in the amount of 0.5-1.5 parts by weight, and preferably, 1.0 parts by weight, based on 100 weight parts of polyol mixture.

Catalyst

A catalyst shortens a reaction time in formation of foams, and controls a flowability of foams in blowing of foams, namely, rising of foams. The catalyst used in the present invention is roughly divided into three kinds, that is, a blowing catalyst, a gelling catalyst and a trimerizing catalyst. The catalyst needs to be suitably controlled in its amount used according to a shape and a structure of an actual refrigerator. In the experiments herein, 5 types of catalysts were combined to be used, of which catalysts B, G and H are used in the present invention. This will now be described in detail.

The catalyst A used in the composition according to the present invention is a gelling catalyst that affects foam and reactivity, such as DMCHA (N,N-dimethylcyclohexylamine). The catalyst A attacks methyl diisocianate (MDI) to make it react with polyol and thereby to produce polyurethane resin. Following examples are taken:

DMCHA: PC-8, PC-33, TC-DMCH, KAO-10

TMHDA: PC-6, TC-MR, KAO-1

TEDA: DABCO33LV, NIAXA-33, TC TEA-L33

The catalyst B used in the composition according to the present invention is a blowing catalyst, such as pentamethyl diethylene triamine (PMDETA). This catalyst facilitates a reaction between water and methyl diisocianate (MDI) and supplies heat required for foaming, to accelerate a resin reaction between polyol and MDI. Following examples are taken:

PMDETA: PC-5, TC-DT, KAO-3

BDMEE: DABCO BL-11, TC-ET, NIAX A-1

The catalyst C is a mixed catalyst obtained by mixing DMCHA and PMDETA in the ratio of 3:1.

The catalyst D is an acid block type blowing catalyst which generates much CO₂ gas by affecting an initial reactivity.

The catalyst E used in the composition according to the present invention is a trimerizing catalyst for a reaction and trimerization of MDI. Following examples are taken:

TMR-2, TMR-13, TMR-30

PC-41, KA0-14, TC-TRC

Isocianate

Any isocianate which can be generally used in preparing polyurethane foam may also be available in the present invention. It may be preferable that the index of isocianate is not high, such as 1.0-1.2 of the general polyurethane foam. For example, methyl diisocianate (MDI) can be used. Isocianate may be used in the amount of 140-170 parts by weight, based on 100 weight parts of a polyol mixture

Chemical Blowing Agent

In the present invention, water was used as a chemical blowing agent in the amount of 2.0-4.0 parts by weight, and preferably, 2.0 parts by weight, based on 100 weight parts of a polyol mixture.

Physical Blowing Agent.

Cyclopentane was used as a physical blowing agent for a composition of the present invention. Besides, HCFC-114b and CFC-11 were used for comparison in the experiments.

### BRIEF DESCRIPTION OF THE DRAWINGS

FIG. 1 illustrates a testing method to measure an adhesive strength;

FIG. 2 is a graph showing a process capability analysis of foam in accordance with Example 2 of the present invention; and

FIG. 3 is a graph showing a process capability analysis of foam in accordance with Example 3 of the present invention; and

### BEST MODE FOR CARRYING OUT THE PREFERRED EMBODIMENTS

Preferred embodiments will now be described but the present invention is not limited thereto.

TABLE 1

| | | Examples | | | | |
|---|---|---|---|---|---|---|
| | | Cyclopentane | | | HCF-141b | CFC-11 |
| | | group | | | group | group |
| | | 1 | 2 | 3 | 4 | 5 |
| Row | Polyol A | 40 | | | 40 | 30 |
| material | Polyol B | 30 | 40 | 40 | 30 | 20 |
| | Polyol C | | 30 | | | |
| | Polyol D | 10 | | | 10 | |
| | Polyol E | 20 | | | 20 | 10 |
| | Polyol F | | | | | 20 |
| | Polyol G | | 30 | 30 | | 10 |
| | Polyol H | | | 30 | | |
| | Polyol I | | | | | 10 |
| | Water | 2.0 | 2.0 | 2.0 | 2.0 | 2.0 |
| | Catalyst A | | 0.6 | 0.6 | 0.5 | |
| | Catalyst B | | 0.4 | 0.4 | 0.6 | |
| | Catalyst C | 0.6 | | | | 1.0 |
| | Catalyst D | 0.4 | | | | 0.5 |
| | Catalyst E | 0.5 | 0.5 | 0.5 | 0.4 | 0.5 |
| | Silicon | 2.0 | 2.0 | 2.0 | 2.0 | 2.0 |
| | surface- | | | | | |
| | active agent | | | | | |
| | PFA | | 1.0 | 1.0 | | |
| | Physical | 17 | 17 | 17 | 40 | 30 |
| | blowing agent | | | | | |
| | Polyisocianate | 148.2 | 148.2 | 148.2 | 140 | 140 |

In Table 1, the unit of injection amount is pbw (parts by weight).

Foam was prepared by sufficiently mixing the components in the compositions according to Examples 1-5 of Table 1 in such a proper way as to completely exhibit physical properties of each component, according to a general polyurethane foam preparing method.

A core density, a dosage (Just Pack), K-factor, a demolding property and an adhesive strength of the obtained foams of five types were measured, and the result was shown in Table 2. The adhesive strength was measured, as followings.

Measurement of Adhesive Strength

A test sample of a material having the size of 100 mm×40 mm with a hole of φ 4.5 (Galva, the weakest among refrigerator materials) was used for testing adhesive strength. The density of polyurethane foam was 32-34 kg/m² in case of the cyclopentane-based foam of Examples 1-3, 30-32 kg/m² in case of the HCFC-141b-based foam of Example 4, and 29-31 kg/m² in case of the CFC-11-based foam of Example 5. The number of test samples was 15.

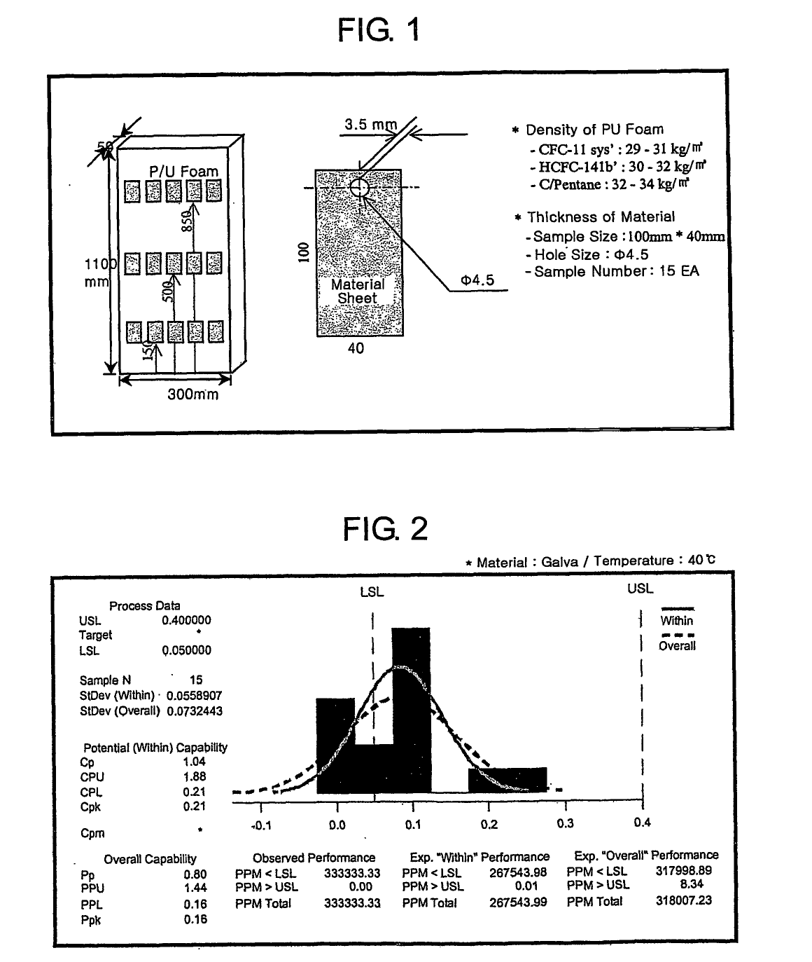

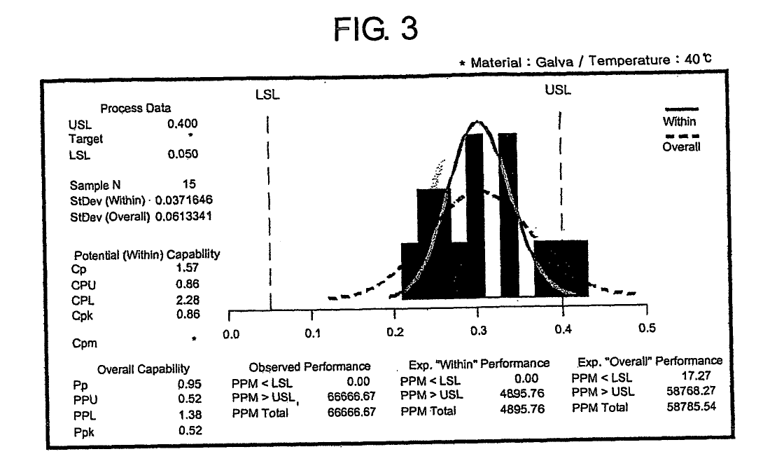

As shown in FIG. 1, a material was attached to a Brett mold and foamed at the core density of polyurethane foam. The material-attached positions were 150 mm, 500 mm and 850 mm of the total length of 1100 mm, on the basis of a lower end. 5 minutes later, it was demolded and left for one hour at a room temperature. A force applied to detach the material by using a push-pull gage was measured to evaluate an adhesive strength and the result was shown in Table 2. FIGS. 2 and 3 are graphs showing a process capability analysis of foams according to Examples 2 and 3, indicating a distribution of low and high adhesive strengths.

TABLE 2

| | Example 1 | Example 2 | Example 3 | Example 4 | Example 5 |
|---|---|---|---|---|---|
| Core density (kg/m²) | 31.54 | 29.94 | 30.51 | 28.90 | 27.50 |
| Injection amount (g) | 517 | 495 | 497 | 475 | 425 |
| Compression strength (kg/cm, 25° C.) | 1.45 | 1.44 | 1.52 | 1.51 | 1.15 |
| K-factor (kcal/m · hr · ° C.) | 0.01654 | 0.01644 | 0.01668 | 0.01545 | 0.01567 |
| Demolding property (%) | 2.19 | 2.10 | 1.87 | 1.95 | 2.11 |
| Adhesive strength (kg/cm²) | 0.112 | 0.085 | 0.304 | 0.091 | 0.094 |

As noted from Table 2, the prepared polyurethane foams differ in the properties and the characteristics depending on their compositions. As a blowing agent, Examples 1 to 3 use cyclopentane groups, Example 4 uses HCFC-141b, and Example 5 uses CFC-11. Since the construction of the systems differs depending on the type of the blowing agent used, there are differences in the insulation characteristics and dosage (Jus Pack).

A characteristic that the present invention aims to improve is the adhesive strength. As noted from the property of Example 3, the adhesive strength is as high as to be almost double compared to other Examples. Besides the adhesive strength, other properties of the polyurethane foam prepared from the composition of the Example 3 are the same as those of the Examples 1 and 2, and also do not make a big difference with the properties of Examples 4 and 5.

Especially, in view that Example 2 and 3 have a difference only in the composition of the basic polyol, it can be concluded that the composition of polyol has a large effect on the adhesive strength. The higher adhesive strength in Example 3 than that of other systems is due to using a polyol component obtained by using a TDA with low viscosity as an initiator. However, this component is disadvantageous in that it has a low demolding property, in spite of the excellent heat conductivity and adhesive strength. Thus, a sucrose/glycerin with lower viscosity than that used in Example 2 was used to improve a flowability and stability of prepared polyurethane foam. In addition, this component exhibits excellent adhesive strength and demolding property. Meanwhile, when using sucrose/glycerin with high viscosity, the adhesive strength and flowability were relatively low, but heat conductivity and demolding property were good.

From the results in Table 2, it can be known that the composition for preparing polyurethane foam in accordance with Example 3 shows increased adhesive strength without degradation of other properties such as the demolding property, the heat conductivity and the like.

### INDUSTRIAL APPLICABILITY

As so far described, the composition for preparing rigid polyurethane foam has the following advantages. That is, for example, since the composition uses water and cyclopentane as a blowing agent, there is no possibility of damaging an environment as the composition using conventional CFC-based or HCFC-based blowing agent does. In addition, since the adhesive strength is improved nearly double the existing composition, with maintaining the major characteristics of the foam, the composition can be suitably applied to construct an insulation material, and especially, a refrigerator.

1. A composition for preparing rigid polyurethane foam comprises:
(1) 100 weight parts of a polyol mixture consisting of:
40-50 weight parts of polyol B having a OH-value of 390, which is obtained by polymerization of an organic oxide using toluene diamine (TDA) of a tetra-valent functional group as an initiator; 30-40 weight parts of polyol G having a OH-value of 450, which is obtained by mixing sucrose of a octa-valent functional group and glycerin of tri-valent functional group; and 20-30 weight parts of polyol H having a OH-value of 430, which is obtained by mixing sucrose of a octa-valent functional group and glycerin of tri-valent functional group;
(2) 2.0-4.0 weight parts of water;
(3) 0.3-3.0 weight parts of catalyst mixture consisting of 0.1-1.0 weight parts of gelling catalyst A; 0.1-1.0 weight parts of blowing catalyst B; and 0.1-1.0 weight parts of trimerizing catalyst E;
(4) 1.0-4.0 weight parts of a silicon surface-active agent;
(5) 0.5-1.5 weight parts of PFA (polyfluoroalcane);
(6) 10-20 weight parts of cyclopentane; and
(7) 140-170 weight parts of polyisocianate.

2. A composition for preparing rigid polyurethane foam according to claim 1, comprises;
(1) 100 weight parts of a mixed polyol consisting of:
40 weight parts of polyol B having a OH-value of 390, which is obtained by polymerization of an organic oxide using toluene diamine (TDA) of a tetra-valent functional group as an initiator; 30 weight parts of polyol G having a OH-value of 450, which is obtained by mixing sucrose of a octa-valent functional group and glycerin of tri-valent functional group; and 20-30 weight parts of polyol H having a OH-value of 430, which is obtained by mixing sucrose of a octa-valent functional group and glycerin of tri-valent functional group;
(2) 2.0 weight parts of water;
(3) 1.5 weight parts of catalyst mixture consisting of 0.6 weight parts of gelling catalyst A; 0.4 weight parts of blowing catalyst B; and 0.5 weight parts of trimerizing catalyst E;
(4) 2.0 weight parts of a silicon surface-active agent;
(5) 1.0 weight parts of PFA (polyfluoroalcane);
(6) 17 weight parts of cyclopentane; and
(7) 148.2 weight parts of polyisocianate.

3. A rigid polyurethane foam prepared by the composition of claim 1 or 2.
